(19) United States
(12) Patent Application Publication
(10) Pub. No.: US 2014/0238376 A1
(43) Pub. Date: Aug. 28, 2014

(54) FOLDABLE BASE FOR TILE CUTTER

(71) Applicant: STANLEY BLACK & DECKER, INC., New Britain, CT (US)

(72) Inventors: Thomas COURTEMANCHE, Bristol, CT (US); Karl VANDERBEEK, Germantown, OH (US)

(73) Assignee: STANLEY BLACK & DECKER, INC., New Britain, CT (US)

(21) Appl. No.: 13/779,055

(22) Filed: Feb. 27, 2013

(51) Int. Cl. B28D 1/22

(52) U.S. Cl. CPC B28D 1/225
USPC 125/23.01

(57) ABSTRACT

A combination manual tile cutter and a method of using the same. A manual tile cutter has an elongated cutting device mounted on a central support base and a pair of side supports pivotally connected on opposite sides of the central support base. The side supports are configured for pivotal movement between a first, open position to provide a generally planar support surface to support a work piece and a second, closed position disposed upwardly from the support base and configured to generally enclose the manual tile cutter in a polygonal (e.g., triangular) configuration. In the closed position, mutually adjacent portions of the side supports are configured to provide a hand grip to facilitate carrying of the manual tile cutter.

### BACKGROUND

1. Field

The present disclosure is generally related to the field of tools.

2. Description of Related Art

A tile cutter is a device used to score or cut tiles into smaller pieces. Manual tile cutters can be used to manually score a body of a tile in a straight line so that tile can be broken or split along a scored line. Current manual tile cutters tend to be bulky and can be difficult to carry and store.

### SUMMARY

One aspect of the disclosure provides a combination manual tile cutter. The combination manual tile cutter includes: a manual tile cutter comprising an elongated cutting device mounted on a central support base, and a pair of side supports pivotally connected on opposite sides of the central support base. The pair of side supports are configured for pivotal movement between a first, open position, wherein the side supports cooperate with the central support base to provide a generally planar support surface to support a work piece, and a second, closed position, wherein the side supports are disposed upwardly from the support base and configured to generally enclose the manual tile cutter in a triangular configuration. In the closed position, mutually adjacent portions of the side supports are configured to provide a hand grip to facilitate carrying of the manual tile cutter.

Another aspect of the disclosure provides a combination tile cutter including: a manual tile cutter comprising an elongated cutting device mounted on a central support base and side supports connected on opposite sides of the central support base. The side supports are configured for movement between a first, open position, wherein the side supports cooperate with the central support base to provide a generally planar support surface to support a work piece, and a second, closed position wherein the side supports and central support base are configured to generally enclose the manual tile cutter in a polygonal configuration. In the closed position, ends of the side supports are configured to provide a hand grip to facilitate carrying of the manual tile cutter.

Other features and advantages of the present disclosure will become apparent from the following detailed description, the accompanying drawings, and the appended claims.

### BRIEF DESCRIPTION OF THE DRAWINGS

FIG. 1 illustrates a perspective view of a combination manual tile cutter in a first, open position in accordance with an embodiment of this disclosure.

FIG. 2 illustrates a top view of the combination manual tile cutter of FIG. 1.

FIG. 3 illustrates a side view of the combination manual tile cutter of FIG. 1.

FIG. 4 illustrates a front view of the combination manual tile cutter of FIG. 1.

FIGS. 5A and 5B illustrate side and end perspective views, respectively, of exemplary scorers or cutters configured for use with the combination manual tile cutter of FIG. 1 in accordance with various embodiments.

FIG. 6 illustrates a detailed view of a head portion of the combination manual tile cutter of FIG. 1.

FIG. 7 illustrates a detailed, perspective view of guide arms or rails of the combination manual tile cutter of FIG. 1 in accordance with an embodiment of this disclosure.

FIG. 8 illustrates a detailed view of the features shown in FIG. 7.

FIG. 9 illustrates a side, perspective view of the combination manual tile cutter of FIG. 1.

FIG. 10 illustrates a perspective view of the combination manual tile cutter of FIG. 1 in a second, closed position in accordance with an embodiment of this disclosure.

FIG. 11 illustrates a top view of the combination manual tile cutter of FIG. 10.

FIG. 12 illustrates a side view of the combination manual tile cutter of FIG. 11.

FIG. 13 illustrates a front view of the combination manual tile cutter of FIG. 12.

### DETAILED DESCRIPTION

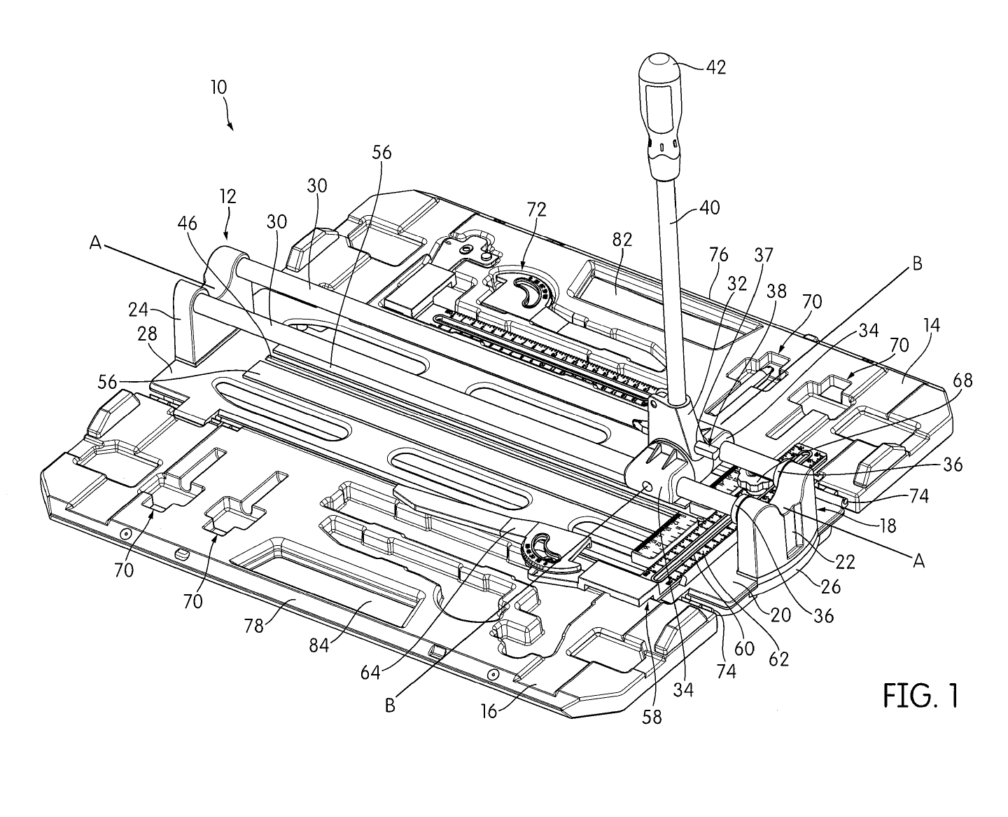

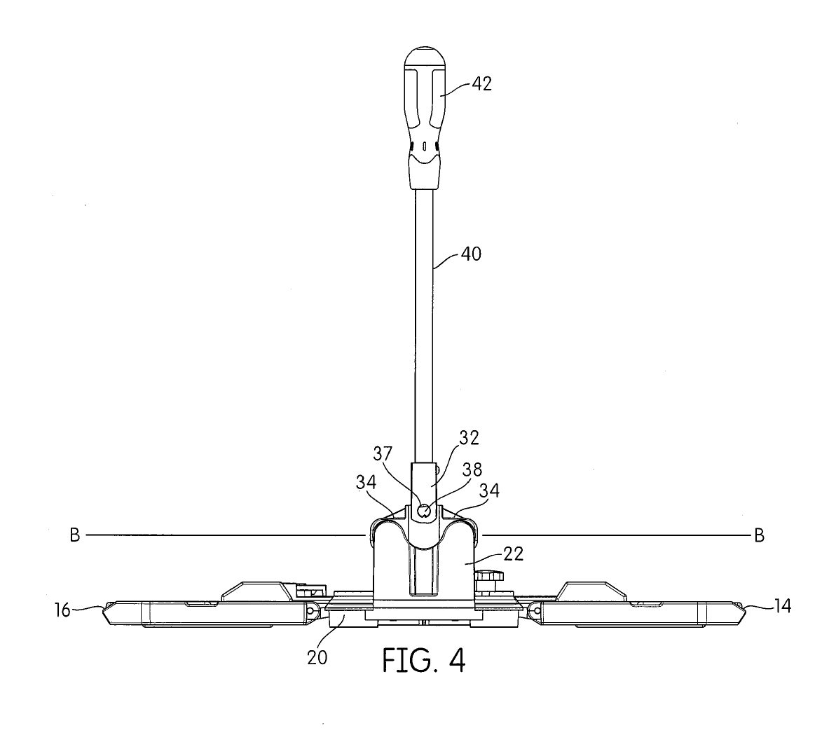

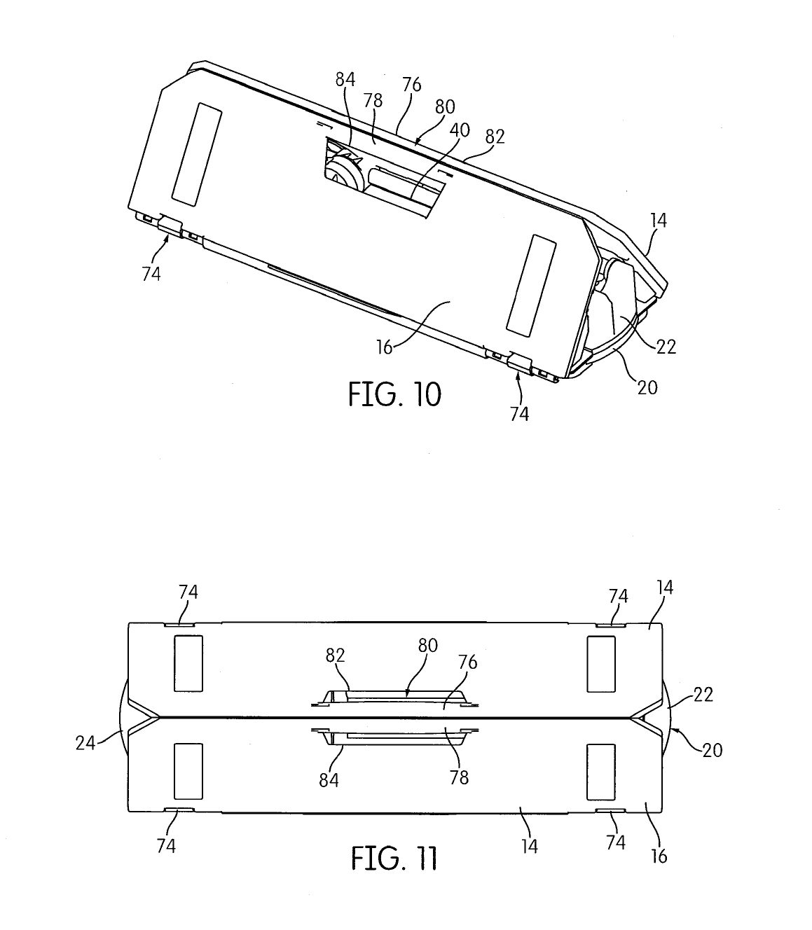

FIGS. 1-4 illustrate different views of a combination manual tile cutter 10 in a first, open position in accordance with an embodiment of this disclosure. The combination includes a manual tile cutter 12 and a pair of side supports 14 and 16. As described further below, the pair of side supports 14 and 16 are configured for pivotal movement between a first, open position wherein the side supports cooperate with a central support base 20 to provide a generally planar support surface to support a work piece (see FIGS. 1-4) and a second, closed position wherein the side supports 14 and 16 are disposed upwardly from the central support base 20 and configured to generally enclose the manual tile cutter 12 in a polygonal configuration. As illustrated in FIGS. 10-13, for example, the side supports 14 and 16 can cooperate with the central support base 20 to generally enclose the manual tile cutter 12 in a generally triangular or other polygonal configuration. The central support base 20 can be formed from any number of materials.

FIGS. 1-4 illustrate alternate views of the combination 10 in a first, open position, configured for use. As shown, the manual tile cutter includes an elongated cutting device 18 mounted on the central support base 20. The central support base 20 is configured to support a tile (not shown) that is going to be scored or cut by the elongated cutting device 18. The elongated cutting device 18 includes a first bracket 22 connected at a first end 26 of the central support base 20 and a second bracket 24 connected at a second end 28 of the central support base 20. A parallel, elongated guide arms 30 (or rails or rods) are connected at opposite end thereof to the brackets 22 and 24, respectively as shown in the Figures, and are positioned above the central support base 20. The elongated guide arms 30 carry a cutter mechanism 31. The cutting mechanism 31 includes a head portion 32 and sliders 34. The head portion 32 is pivotally connected to sliders 34. The sliders 34 are configured for sliding movement along the elongated guide arms 30. Thus, the head portion 32 is configured for longitudinal movement along a scoring and breaking path along longitudinal axis A-A of the central support base 20, as sliders 34 slide on the guide arms 30. The sliders 34 each comprise a body with a hole therethrough for receipt of each of the elongated guide arms. In an embodiment, the sliders 34 have a pivot pin (not shown) extending between them, and the head portion 32 pivots about the pivot pin.

Stoppers 36 can be provided at either or both ends of the elongated guide arms 30 to reduce or stop force by the sliders 34 against the brackets 22 and 24.

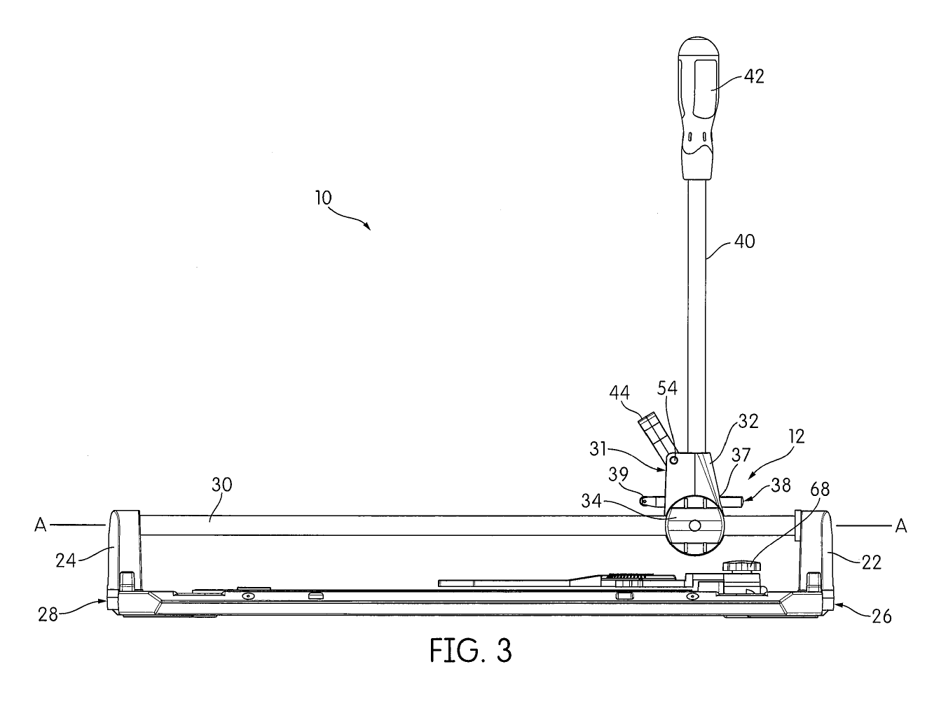

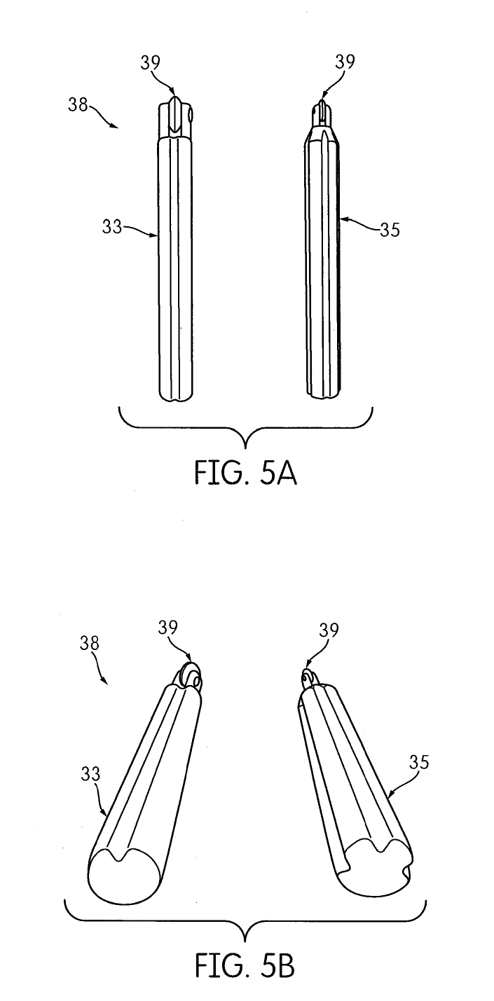

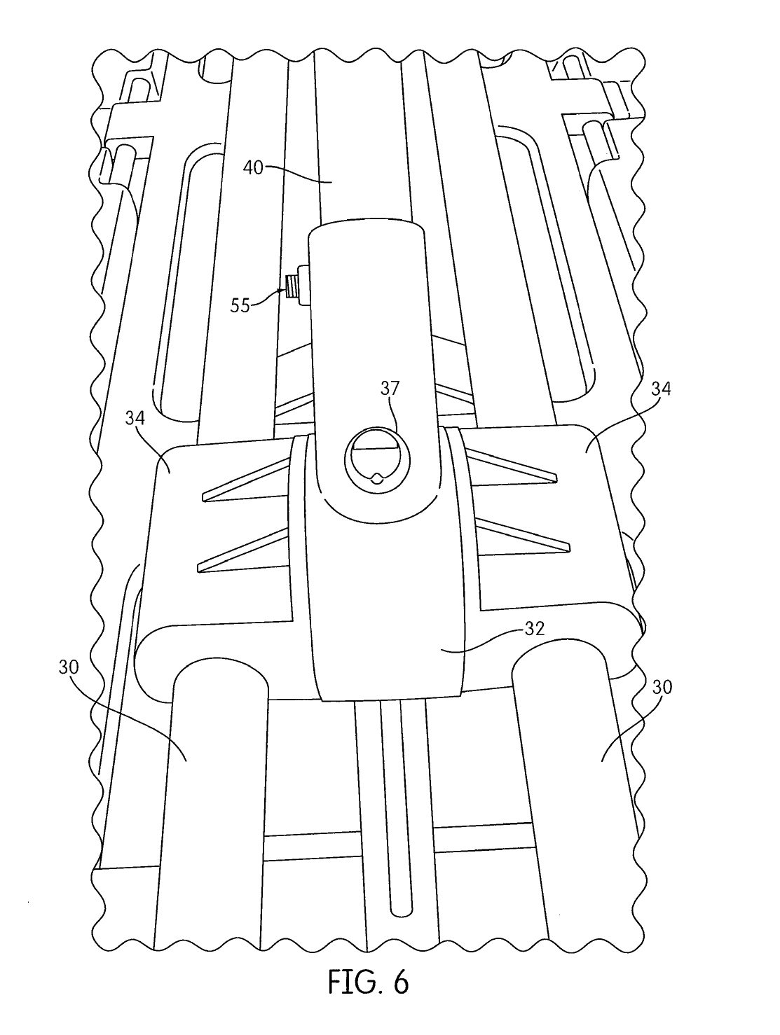

The head portion 32 has a through hole 37 for receipt of a cutter or a scorer 38, as shown in FIG. 6. A cutter or scorer 38 has a tip 39 (e.g., see FIG. 3 or FIG. 5A) configured for placement against a tile provided on central support base 20 to cut or score the tile as it is moved against the tile in a longitudinal direction. Any type of cutter or scorer can be used with head portion 32, and such cutters or scorers can be interchanged. As shown in FIGS. 5A and 5B, for example, a first cutter 33 or a second cutter 35 can be selected for use as the cutter or scorer 38 in head portion 32. Such cutters are designed to score tile using cutter blades in the form of wheels with cutting edges, for example. The cutters can vary in size and/or dimension. A selected type of cutter or scorer is selected and inserted through the through hole 37 such that the tip 39 of the selected cutter or scorer extends from head portion 32 for engagement with a tile (see FIG. 3).

In one embodiment, the through hole 37 is a threaded opening. That is, the through hole 37 is configured to comprise threads that correspond to threads on a body of the cutter or scorer 38. In another embodiment, the through hole 37 comprises a shape that corresponds to the shape of the body of the cutter or scorer 38. Such threading or corresponding shape of the through hole 37 reduces movement of the cutter or scorer 38 within the head portion 32 and thus reduces vibration during cutting or scoring of tiles.

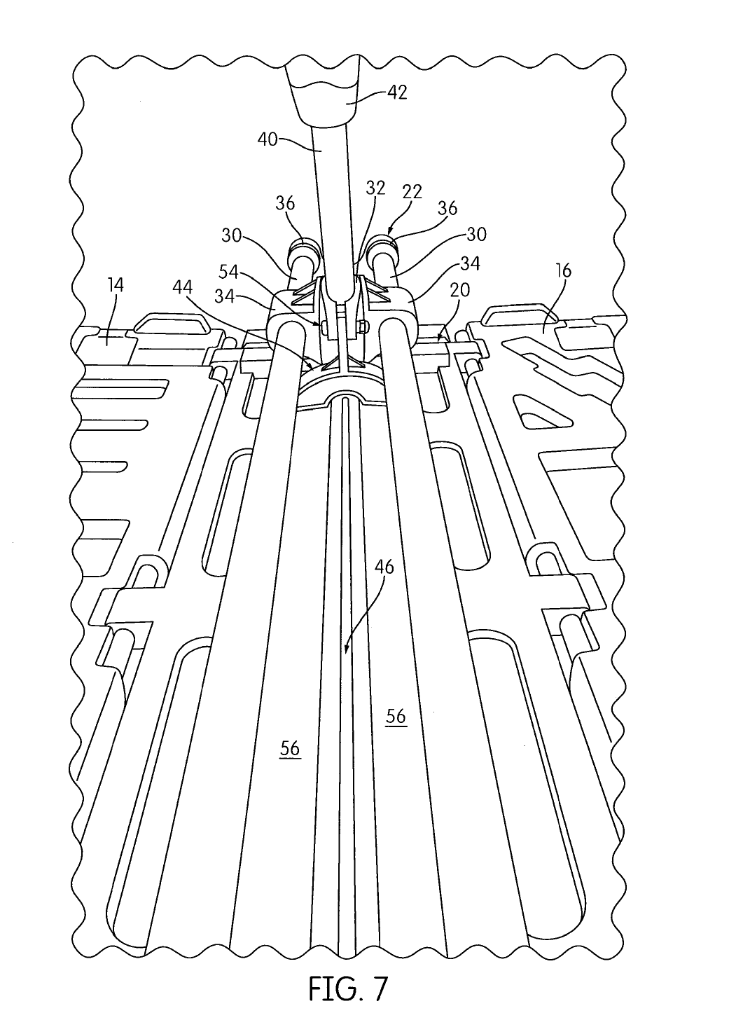

For example, as shown in FIGS. 5A and 5B, the first cutter 33 comprises a single flute along a length of its body. In one embodiment, the through hole 37 can include at least one protrusion, as shown in FIG. 7, configured to align within the single flute of the cutter (e.g., cutter 33) as it is inserted into the head portion 32. Also shown in FIGS. 5A and 5B is second cutter 35, which comprises three flutes around along the length of its body. In an embodiment, the at least one protrusion of the through hole 37 is configured to align within one of the flutes of the cutter (e.g., cutter 35) as it is inserted into the head portion 32. Of course, such embodiments are not meant to be limiting. In accordance with another embodiment, the through hole 37 can comprise other alignment shapes for holding a cutter or scorer therein, including, but not limited to, detents.

The manual tile cutter 12 further comprises an elongated handle 40 connected at one end to the head portion 32 and having an ergonomic grip 42 at its opposite end. The elongated handle 40 is configured to move the head portion 32 and the cutter or the scorer 38 in a longitudinal direction along axis A-A of the central support base 20. The head portion 32 can also pivot about lateral axis B-B (axis B-B extending through the aforementioned pivot pin). The head portion 32 can also be rotated about axis B-B to engage and disengage the cutter or scorer within the head portion 32 with a tile on the central support base 20. A user can grasp the ergonomic grip 42 of the handle 40 to rotate the head portion 32 downwardly (e.g., clockwise) to engage and upwardly (e.g., counterclockwise) to disengage the cutter or scorer 38 with a tile. When engaged with the tile and ready for use, the cutter or scorer 38 is moved in a longitudinal direction by moving the handle 40 and thus head portion 32 and sliders 34. The user can score a tile while maintaining a constant scoring pressure by moving the head portion 32 via sliders 34 along the elongated guide arms 30 from first bracket 22 towards second bracket 24 along a length of the tile to at least score the tile.

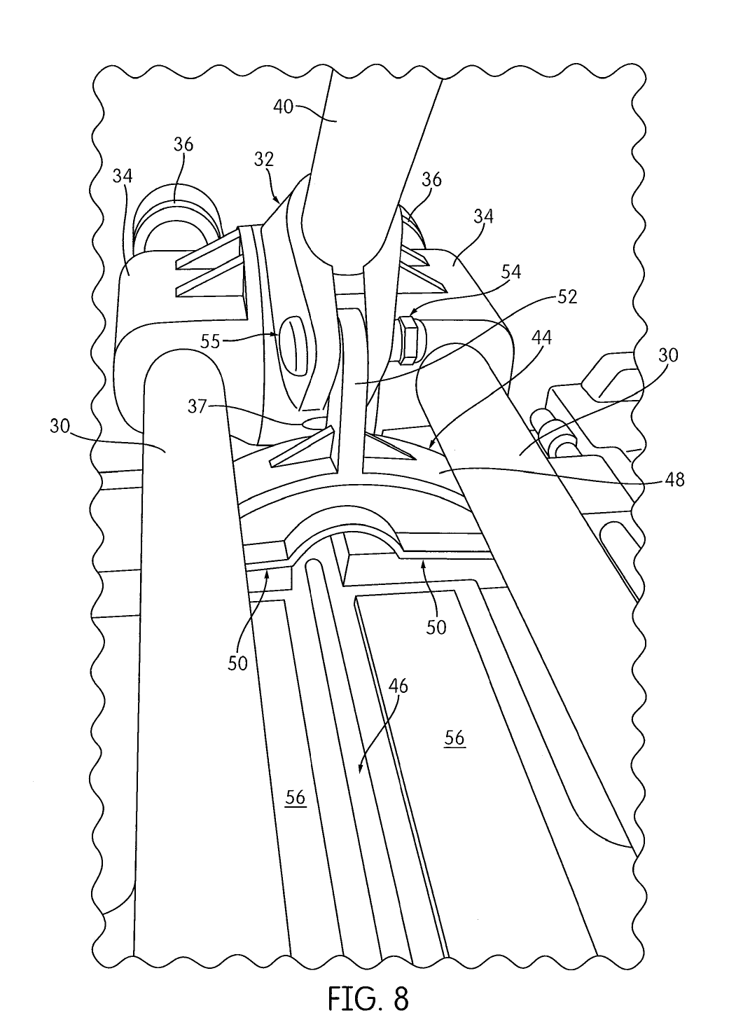

As shown in FIGS. 7, 8, and 9, also attached to head portion 32 is a breaker portion 44. The breaker portion 44 is configured for movement into contact with a scored tile to apply force and pressure thereto to break the tile along its scored line. The breaker portion 44 comprises a body 48 that is substantially U-shaped (inverted) with two flat edges 50 and a connection portion 52, as shown in detail in FIG. 8. The breaker portion 44 is connected to the head portion 32 via its connection portion 52 such that a hinge connection 54 is formed, allowing the body 48 of the breaker portion 44 to rotate relative to the head portion 32. In particular, a bolt 55 extends through holes in the head portion 32 and connection portion 52 to serve as a hinge portion (see FIG. 8). As shown, the body 48 is positioned below the elongated guide arms 30 when the tile cutter is configured for use. FIG. 3 depicts, for explanatory purposes only, the handle 32 in a substantially vertical position and showing both the breaker portion 44 and through hole 37 positioned above the elongated guide arms 30 simply to illustrate the position of the breaker portion 44 that is hingedly connected to the head portion 32 relative to the position of the through hole 37 on the head portion 32. When configured for use, however, both of the breaker portion 44 and through hole 37 are positioned below the elongated guide arms 30.

Additionally, upward or lifting rotation of handle 32 to a substantially vertical position as shown in FIGS. 1-4 can be limited and/or prevented by the breaker portion 44. For example, when configured for use, the body 48 is placed under the elongated guide arms 30. In an embodiment, the body 48 is designed to stop upward or lifting rotation of the handle 32 about lateral axis B-B (e.g., in a counterclockwise direction) through its engagement with an underside of each of the elongated guide arms 30 in that its shape is larger than the space provided between the arms 30. For example, as can be seen by viewing FIGS. 7, 8, and 9, the U-shape of the body 48 can limit lifting of the handle.

The body 48 of the breaker portion 44 is positioned on and connected to head portion 32 such that when handle 40 is used to cut or score a tile, it is not in contact with the tile. That is, when a cutter 38 is inserted into head portion 32, its tip and body are configured to extend through the head portion 32 such that when its tip 39 contacts the tile, the breaker portion 44 hangs above the tile (and below the elongated guide arms 30) without contacting with the tile (e.g., see FIG. 8). The flat edges 50 of the breaker portion 44 are configured for selective contact with a tile, on either side of the scored portion of the tile. To apply force to a scored tile, the handle 40 is lifted and rotated about lateral axis B-B (e.g., in a counterclockwise direction), forcing the flat edges 50 of the breaker portion 44 into contact with the tile. The handle 40 can be alternatingly rotated and moved longitudinally along the elongated guide arms 30 to move the head portion 32 and thus the breaker portion 44 along a length of a scored tile to selectively apply pressure to the edges beside the score line to split or break the tile.

The central support base 20 also includes a breaker spline 46 extending in a direction that is parallel, adjacent to, and along the scoring path. As shown in FIGS. 7, 8, and 9, the breaker spline 46 extends down a center portion of the central support base 20 parallel to longitudinal axis A-A. The breaker spline 46 is provided for contact with an opposite side or underside of the tile, adjacent a score line of a scored tile, on the central support base 20. The breaker spline 46 assists in breaking the tile along the scoring path, in that, as the breaker portion 44 applies pressure downward on the tile on opposite sides of the score line, the underside of the tile is pushed downward in contact with the spline 46 along, and directly beneath, the scored path, allowing the tile to be split over the breaker spline 46. With enough pressure upon contact, splitting of the tile along its score line is initiated, providing a clean break. The spline 46 can have a generally pointed shape with flat edges for applying pressure on an area underneath the scored line when the breaker portion 44 is forced downwardly on opposite sides of the scored line.

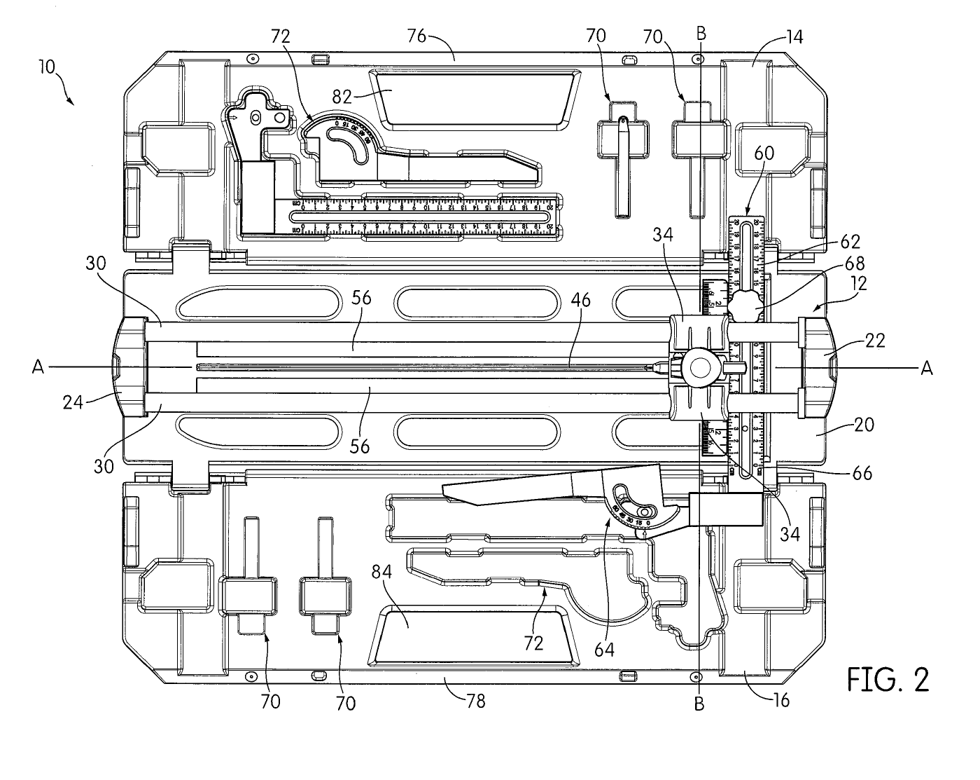

The central support base 20 also includes pads 56 or support rests on either side of spline 46, as seen in FIG. 2, for example. Pads 56 are designed to support each side of the tile adjacent its score line after cutting or scoring. The pads 56 can be adhesively fixed to the central support base 20. An elongated area or space can be provided on either side of the spline 46 between an edge of the spline 46 and an edge of each of the pads 56.

Further, the central support base 20 includes an area 58 for receipt of a miter gauge 60 with a positioning arm 62 and a guide arm 64, shown in FIGS. 1 and 2. The positioning arm 62 of the miter guide 60 has slot 66 therein to allow the miter gauge 60 to be adjusted laterally to move the miter gauge 60 and set its guide arm 64 at a desired scoring path. The positioning arm 62 includes measuring (dimension) indicia thereon to enable the user to move the guide arm 64 to a selected measurement or position so that the tile can be scored and cut at a predetermined width. One or more adjustment screws 68 with knobs thereon are provided to extend through the slot 66 in the positioning arm 62 of the miter guide 60 for threaded engagement with a bore(s) (not shown) in the central support base 20. The adjustment screw(s) 68 can be loosened and tightened to secure and hold the miter gauge 60 in place within the receipt area 58 of the central support base 20. In use, the user can hold a tile against the guide arm 64 during scoring.

In an embodiment, each of the pair of side supports comprises at least one integrated storage area 70 for holding an accessory therein. The storage area(s) 70 may be provided in the form of indentations, openings, slots, or the like. The one or more storage areas 70 are shaped for receipt of a corresponding accessory. In an embodiment, the at least one integrated storage area 70 is configured to hold at least one cutter or a scorer for use in the manual tile cutter. As shown in FIG. 2, two areas 70 are provided on each side support 14 and 16 for holding cutters or scorers. In an embodiment, another storage area 72 is provided for holding the miter gauge 72. Other accessories or tools for use with the manual tile cutter 12 may also be held or housed within side support 14 or 16, which can be understood by one of ordinary skill in the art.

The pair of side supports 14 and 16 is formed from any number of materials. In an embodiment, the pair of side supports 14 and 16 is formed from a molded plastic.

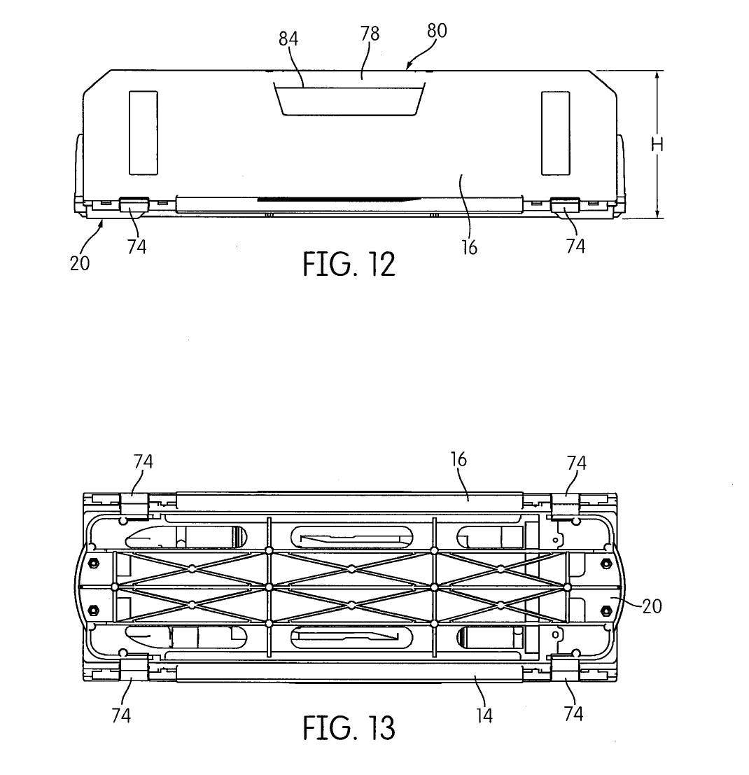

As noted previously, the pair of side supports 14 and 16 can be pivoted between a first, open position, as shown in FIGS. 1-4 and a second, closed position, as shown in FIGS. 10-13. In an embodiment, each side support 14 and 16 is connected to central support base 20 via one or more hinges 74. As shown in FIG. 10, for example, in the second, closed position, the side supports 14 and 16 are disposed upwardly from the central support base 20 and configured to generally enclose the manual tile cutter 12 in a polygonal (e.g., triangular, square, trapezoidal) configuration to transport and store the combination manual tile cutter 10. In the second, closed position, the combination has a height H, as shown in FIG. 12. The height H of the closed combination can be between approximately 4.5 inches (˜114 mm) and approximately 8 inches (˜203 mm). In one embodiment, the height H is approximately 6 inches (˜155 mm).

To close the combination manual tile cutter 10, the head portion 32 of the manual tile cutter 12 is rotated further downwardly about axis B-B towards the central support base 20 and between elongated guide arms 30. In the closed position, mutually adjacent portions 76 and 78 of the side supports 14 and 16, respectively, are configured to provide a hand grip 80 to facilitate carrying of the manual tile cutter 12. The pair of side supports 14 and 16 in combination with the central support base 20 act as a carrying case for the manual tile cutter 12 therein. Accordingly, by incorporating the side supports 14 and 16 with the central support base 20, the combination eliminates a need to have a separate storage case for the manual tile cutter 12. In addition to enable greater portability of the tile cutter, the combination encloses the manual tile cutter 12 and its accessories within a housing, providing protection to such devices and limiting damage during transportation of the tile cutter.

As shown in FIG. 11, for example, each side support 14 and 16 includes an opening or cut-out portion 82 and 84 respectively therein which are mutually and substantially aligned for receipt of a hand of a user for gripping of the mutually adjacent portions 76 and 78 of side supports 14 and 16 that form the hand grip 80.

In one embodiment, the mutually adjacent portions 76 and 78 of the side supports 14 and 16 meet and touch each other when placed in the second, closed position. In another embodiment, the mutually adjacent portions 76 and 78 do not touch in the second, closed position. Despite limited or no contact when in the second, closed position, the side supports 14 and 16, along with central support base 20, can still provide a structure that is generally triangular in configuration (or some other polygonal shape) when enclosing the manual tile cutter 12 in the second, closed position, as contemplated herein.

In an embodiment, an optional lock mechanism (not shown) may be provided on the hand grip 80. For example, a locking portion can be provided on one adjacent portion, e.g., portion 82, while a receipt portion for engagement of the locking portion is provided on the other adjacent portion, e.g., portion 84. Although not shown, one of ordinary skill in the art can apply such a locking mechanism for at least temporary securement of the mutually adjacent portions 76 and 78 of the hand grip 80 in the second, closed portion.

To use the combination manual tile cutter 10, a user can place the device on a surface and pivots the pair of side supports 14 and 16 about its hinges 74 downwardly relative to the central support base 20 into the first, open position into a generally planar support surface as shown in FIG. 1, for example. “Generally planar surface” does not necessarily mean that the surfaces must lie exactly in the same plane, but rather refers to surface portions that lie in or close to a plane so as to support a generally flat workpiece. Accessories are then assembled for use. A selected cutter or the scorer 38 is removed from its integrated storage area 70 in one of the pair of side supports 14 or 16. The selected cutter or scorer 38 is inserted into and through the through hole 36 of the pivotally mounted head portion 32 of the manual tile cutter 12. The threads of the through hole 36 can be used to lock in the cutter in its proper position for use. A miter gauge 60 can also be removed from its storage area 72 in one of the pair of side supports 14 or 16. The adjustment screw(s) 68 can be turned and loosened from the bores of the central support base 20. The positioning arm 62 of the miter gauge 60 is placed within the receipt area 58 of the central support base 20 and moved laterally for placement of guide arm 64 in a desired position. The adjustment screw(s) 68 are then inserted through the slot 66 of the positioning arm 62 into respective bores and turned and retightened to hold the miter gauge 60 in a selected place. A tile is placed on the central support base 20 the guide arm 64 of the miter gauge 60. The head portion 32 is rotated via elongated handle 40 about lateral axis B-B and positioned at its starting point for scoring when the cutter in the head portion 32 engages a top surface of the tile.

The user then grasps the grip 42 and pulls the handle 40 to move the pivotally mounted head portion 32 in a longitudinal direction of the central support base 20 along longitudinal axis A-A. As the user pulls the handle 40, the sliders 34 are moved along the elongated guide arms 30 thereby moving its attached head portion 32. Accordingly, the cutter or scorer 38 is moved longitudinally along the tile to score the tile. The user may move the cutter or scorer 38 one or more times in the longitudinal direction to ensure and/or deepen the score line along the tile.

After scoring the tile, the user positions the breaker portion 44 directly above the edges adjacent the score line of the tile by lifting the handle 40 thereby rotating the head portion 32 about lateral axis B-B. The flat edges 50 of the breaker portion 44 are forced into contact with the tile. As the handle 40 is further lifted, additional force is applied by the breaker portion 44 to the sides opposite the score line. Further, the breaker spline 46 applies force to the opposite side of the score line, i.e., on the underside of the tile. The forces against the scored tile apply pressure to break the tile along its score line. The user can alternately lift, move, and lower the handle 40 to alternately lower, move and lift the breaker portion 44 longitudinally with respect to the tile along its longitudinal scored line to apply force upon the tile along the direction in which the tile is cracking or breaking.

Any number of tiles can be scored and cut using the manual tile cutter 12.

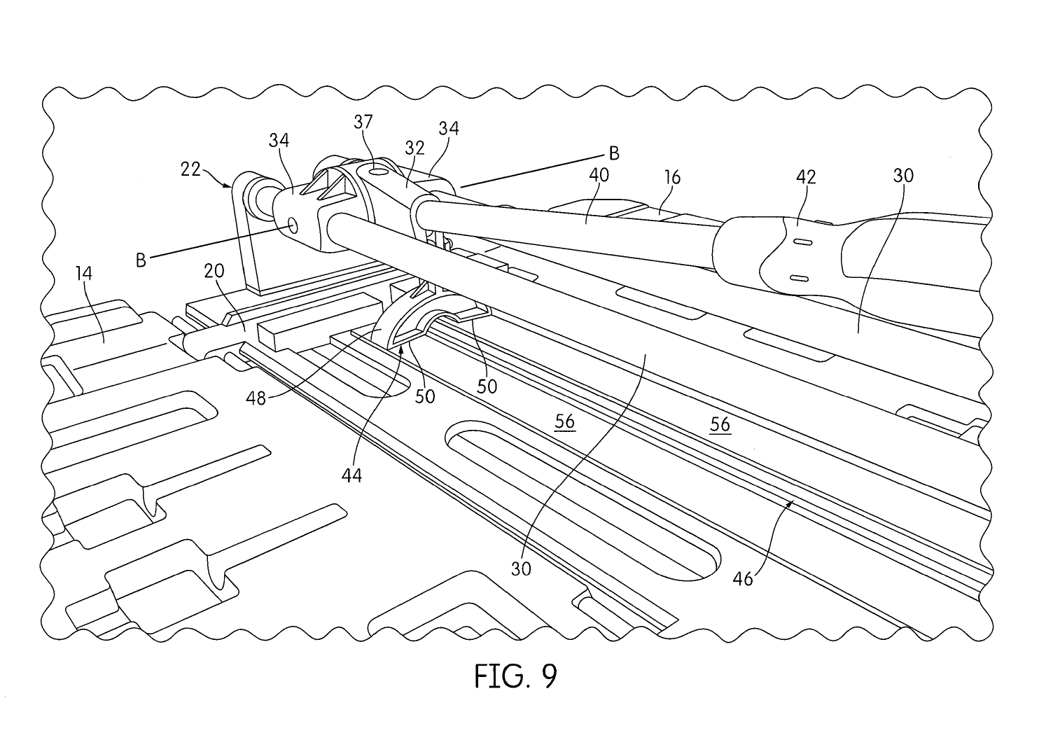

After discontinuing use of the manual tile cutter 12, the accessories (e.g., cutter 38 and miter gauge 60) are removed from the manual tile cutter 12 (e.g., removed from head portion 32 and area 58 on central support base 20). The removed accessories are inserted into their integrated storage areas 70 and 72 in one of the pair of side supports 14 or 16. The handle 40 is rotated about lateral axis B-B downwardly towards the central support base 20 (e.g., see FIG. 9). In one embodiment, the ergonomic grip 42 and at least part of the handle 40 can be placed through the elongated guide arms 30. Then, the pair of side supports 14 and 16 is pivoted upwardly about their hinges 74 relative to the central support base 20 into the second, closed position to enclose the manual tile cutter 12 in a triangular configuration as shown in FIG. 10. Mutually adjacent portions 76 and 78 of the side supports 14 and 16 can optionally meet and the openings 82 and 84 of side supports 14 and 16 are substantially aligned to form the adjacent portions of the hand grip 80 for carrying the manual tile cutter 12. The hand grip 80 can be gripped to lift, transport, and move the combination.

While the features of the disclosure have been made clear in the illustrative embodiments set forth above, it will be apparent to those skilled in the art that various modifications may be made to the structure, arrangement, proportion, elements, materials, and components used in the practice of the disclosure. For example, any type of tile can be scored with the herein disclosed combination manual tile cutter 10, including those made of, but not limited to, ceramic, porcelain, glass, and plastic. Also, the features described with reference to the manual tile cutter 12 are not meant to be limiting.

It will be realized, however, that the foregoing preferred specific embodiments have been shown and described for the purpose of illustrating the functional and structural principles of this disclosure and are subject to change without departure from such principles. Therefore, this invention includes all modifications encompassed within the spirit and scope of the following claims.

What is claimed is:

1. A combination manual tile cutter comprising:
a manual tile cutter comprising an elongated cutting device mounted on a central support base, and
a pair of side supports pivotally connected on opposite sides of the central support base and configured for pivotal movement between a first, open position wherein the side supports cooperate with the central support base to provide a generally planar support surface to support a work piece and a second, closed position wherein the side supports are disposed upwardly from the support base and configured to generally enclose the manual tile cutter in a triangular configuration,
wherein in the closed position, mutually adjacent portions of the side supports are configured to provide a hand grip to facilitate carrying of the manual tile cutter.

2. The combination according to claim 1, wherein the pair of side supports are connected to the central support base via hinges.

3. The combination according to claim 1, wherein each of the pair of side supports comprises at least one integrated storage area for holding an accessory therein.

4. The combination according to claim 3, wherein the at least one integrated storage area is configured to hold a cutter or a scorer for use in the manual tile cutter.

5. The combination according to claim 4, wherein the manual tile cutter comprises a pivotally mounted head portion for longitudinal movement along the central support base, and wherein the head portion comprises a through hole for receipt of the cutter or the scorer.

6. The combination according to claim 5, wherein the through hole is a threaded opening.

7. The combination according to claim 5, wherein the manual tile cutter further comprises an elongated handle connected at one end to the head portion and having an ergonomic grip at its opposite end, the elongated handle configured to move the cutter or the scorer in a longitudinal direction of the central support base.

8. A combination tile cutter comprising:
a manual tile cutter comprising an elongated cutting device mounted on a central support base, and
side supports connected on opposite sides of the central support base, the side supports configured for movement between a first, open position, wherein the side supports cooperate with the central support base to provide a generally planar support surface to support a work piece, and a second, closed position wherein the side supports and central support base are configured to generally enclose the manual tile cutter in a polygonal configuration,
wherein in the closed position, ends of the side supports are configured to provide a hand grip to facilitate carrying of the manual tile cutter.

9. The combination according to claim 8, wherein the side supports are connected to the central support base via hinges.

10. The combination according to claim 8, wherein at least one of the side supports comprises at least one integrated storage area for holding an accessory therein.

11. The combination according to claim 10, wherein the at least one integrated storage area is configured to hold a cutter or a scorer for use in the manual tile cutter.

12. The combination according to claim 11, wherein the manual tile cutter comprises a pivotally mounted head portion for longitudinal movement along the central support base, and wherein the head portion comprises a through hole for receipt of the cutter or the scorer.

13. The combination according to claim 12, wherein the through hole is a threaded opening.

14. The combination according to claim 12, wherein the manual tile cutter further comprises an elongated handle connected at one end to the head portion and having an ergonomic grip at its opposite end, the elongated handle configured to move the cutter or the scorer in a longitudinal direction of the central support base.

15. The combination according to claim 8, wherein the polygonal configuration is generally triangular.
